(19) United States
(12) Patent Application Publication
(10) Pub. No.: US 2009/0251891 A1
(43) Pub. Date: Oct. 8, 2009

(54) Portable Illuminator

(76) Inventors: Soonkyo Hong, Seoul (KR); Junghee Yoo, Seoul (KR)

Correspondence Address: John W Renner;Renner Otto Boisselle & Sklar, 1621 Euclid Avenue 19th Floor, Cleveland, OH, 44115, US

(21) Appl. No.: 12/083,264

(22) PCT Filed: Oct. 9, 2006
(86) PCT No.: PCT/KR2006/004053

§ 371 Date: Apr. 7, 2008

(30) Foreign Application Priority Data
Oct. 10, 2005 (KR) 20-2005-0028760

(51) Int. Cl. F21L 4/00; F21V 33/00

(52) U.S. Cl. 362/183; 362/253; 362/157

(57) ABSTRACT

Disclosed is a portable illuminator, capable of variously adjusting an angle and a length and simultaneously charging batteries used in various mobile products while serving as a reading lamp, a table lamp, and any other ordinary lamp. The portable illuminator includes a power supply and control module supplying power to control operation of a lamp, a guide and pivot main body pivotably coupled to the power supply and control module, a slide assembly slidably inserted into the guide and pivot main body, and a lamp module mounted to one end of the slide assembly.

### TECHNICAL FIELD

The present invention relates to a portable illuminator, and more particularly, to a portable illuminator, capable of variously adjusting an angle and a length and simultaneously charging batteries used in various mobile products while serving as a reading lamp, a table lamp, and any other ordinary lamp.

### BACKGROUND ART

In general, a portable illuminator is designed such that a battery is mounted in a main body. A front cover with a built-in lamp is detachably coupled to the front of the main body, a sheet glass is mounted to the front cover, and a switch turning on and off power applied from the battery to the lamp is coupled to the main body.

With respect to the portable illuminator, there has been recently proposed an approach in which the battery has additionally been installed outside the main body, in addition to an existing approach in which the battery has been mounted in the main body. Specifically, the proposed construction has been adapted to connect a pair of jacks to terminals of the existing battery, and have an electric bulb radiating light from above a support connected with the jacks.

Typically, in the case of the 6V battery employed in a portable illuminator having a relatively great bulk among the portable illuminators, its weight and size are set to be heavy and great unlike existing batteries. Hence, there have frequently been proposed approaches in which constituents of the portable illuminator are connected to the existing battery without mounting the battery in the portable illuminator.

In addition to this ordinary structure, various improvements have been suggested. For instance, a reading lamp structure being coupled with a book to allow a user to conveniently read the book in a bright state, a table lamp structure capable of freely adjusting the direction of a lamp, and a portable lamp structure have been suggested.

Among such improvements, an example is disclosed in Korean Utility Model Laid-Open Publication No. 1987-0003420 (Publication No. 1988-0882109) with the title “Portable Reading Lamp.” According to this portable reading lamp, an electric bulb module is connected through a connecting rod with a base having a dry battery box and pivoted about the connecting rod by a pivoting joint. In addition, a U-shaped book clip formed to surround three sides of the base except for a rear side of the base is connected to a rear end of the base, and the book clip is bent at a downward slope starting from an inflection part formed near the rear end.

However, the portable reading lamp is inconvenient to read a book due to a narrow illumination angle of light.

Another example is disclosed in Korean Utility Model Publication No. 1987-010509 with title “Rechargeable Portable Lamp,” in which a storage chamber capable of containing a cord is formed in a case, and elastic rubber valves having a bubble discharge hole are attached to the middle and corner of a battery. However, the rechargeable portable lamp is also inconvenient to read a book due to a narrow illumination angle of light.

Yet another example is disclosed in Korean Utility Model Registration No. 20-0383332, titled “Portable Lamp for Reading Book Using LED,” in which the portable lamp is comprised of a lamp case, a lamp board, a plurality of LEDs, a scattering plate, a transparent window, a flexible tube, a power supply, a power supply switch, an flicker switch, an external power supply connector, a main case, and a clip. The portable lamp has the plurality of LEDs disposed in a row and provides the scattering plate to the transparent window, thereby having a wide illumination angle of light. The portable lamp is provided with a clip, which can be put into a book, so that it is easy to read the book. The portable lamp allows the light transparent window to be replaced by a colored transmission window, thereby providing different color illumination. The portable lamp is provided with a jack, which can be connected with the power supply of a mobile phone, so that it can be turned on by the power supply of the mobile phone regardless of a place. The portable lamp can inform other persons of an emergency situation using a flickering function. However, due to the flexible tube, restoration force is generated to make it difficult to maintain the lamp case at a fixed position, and furthermore an entire size is increased to make it inconvenient to carry the portable lamp.

Besides the related disclosures, there are disclosed Korean Utility Model Publication No. 1992-012548 titled “Portable Illumination Apparatus,” No. 1992-015311 titled “Portable Illumination Apparatus,” and No. 1994-025145 titled “Portable Illuminator.” The present inventor continues a study of the portable illuminator, which has a compact structure and various functions on the basis of the drawbacks of the conventional improvements, thereby providing the present invention.

### DISCLOSURE

### Technical Problem

Therefore, the present invention has been made in view of the above-mentioned problems occurring in the prior art, and it is an object of the present invention to provide a portable illuminator capable of freely adjusting the angle of a lamp module, to which light emitting diodes (LEDs) emitting light are mounted, in upward and downward directions at the request of a user.

It is another object of the present invention to provide a portable illuminator capable of freely adjusting a length in multiple steps by sliding a case to which LEDs are mounted with respect to a main body.

It is yet another object of the present invention to provide a portable illuminator capable of manufacturing a main body and a lamp module in a folder type to be folded and unfolded at various angles.

It is still yet another object of the present invention to provide a portable illuminator capable of maximizing divergence of light from the lamp module to prevent refulgence.

It is still yet another object of the present invention to provide a portable illuminator capable of using a general battery, or recharging and using the general battery at the same time.

It is still yet another object of the present invention to provide a portable illuminator capable of changing various mobile products, and vice versa.

### Technical Solution

In order to accomplish the above objects, according to the present invention, there is provided a portable illuminator, which comprises:

a power supply and control module supplying power to control operation of a lamp;

a guide and pivot main body pivotably coupled to the power supply and control module;

a slide assembly slidably inserted into the guide and pivot main body; and

a lamp module mounted to one end of the slide assembly.

The power supply and control module includes:

a battery holder integrally formed with a shaft retainer at one end thereof in order to insert a pivoting shaft;

a driver installed near the battery holder;

a lamp switch connected to the driver and turning on and off the lamp; and

a cover detachably coupled to the battery holder and the driver by means of sliding in order to close battery holder and the driver.

The portable illuminator further comprises a charger adjacent to the battery holder, wherein the charger is connected with a charging port communicating with the outside.

The guide and pivot main body includes:

a guide plate having a guide ledge protruding downwards for guiding, a pair of slits spaced apart from each other in parallel to longitudinal direction of the guide ledge, and a stopper integrally formed on a bottom surface of the guide ledge between the pair of slits;

a pair of pivot wings integrally formed at one end of the guide plate with spaced apart from each other, and each having a recess formed on an inner wall thereof; and

the pivoting shaft inserted into the shaft retainer and pivotably coupled between the pivot wings via annular rings.

The slide assembly includes:

a main body having a flat guide recess corresponding to the guide ledge of the guide and pivot main body on an inner side thereof, a pair of ears formed apart from each other at one side of the guide recess, a lamp seat integrally formed between the pair of ears, coupling slits formed between each ear and the lamp seat, a pivoting slot formed in the middle of the lamp seat, and a plurality of semi-circular protrusions formed on a top surface of the guide recess; and

a cover having a corresponding structure so as to be coupled to the main body, and provided with coupled protrusions integrally formed at one side thereof so as to be inserted and coupled into the coupling slits formed around the ears.

The lamp module includes:

a lamp holder main body integrally formed with a boss on a rear surface thereof, and formed with first pivot locking pieces on opposite sides thereof;

a circuit board mounted in the lamp holder main body;

a plurality of light emitting diodes (LEDs) mounted on the circuit board; and

an optical window coupled to a front surface of the lamp holder main body, and formed with second pivot locking pieces on opposite sides thereof.

The boss is formed with grooves on opposite sides thereof, and the pivoting slot is provided with a plurality of semi-circular protrusions on opposite inner walls thereof, so as to allow the boss of the lamp module to be pivotably inserted into the pivoting slot of the lamp seat.

The optical window is additionally formed with a plurality of elongate channels formed on an inner surface thereof in order to further diffuse light emitted by the LEDs.

The optical window is subjected to surface treatment by means of etching or polishing.

### DESCRIPTION OF THE DRAWINGS

FIG. 1 is a front perspective view illustrating a portable illuminator according to the present invention;

FIG. 2 is a rear perspective view illustrating the portable illuminator of FIG. 1;

FIG. 3 is an exploded perspective view illustrating a portable illuminator according to the present invention;

FIG. 4 is a detailed view illustrating a power supply and control module of a portable illuminator according to the present invention;

FIG. 5 is a detailed view illustrating operation of a lamp module in a portable illuminator according to the present invention;

FIG. 6 illustrates a sliding operation of a portable illuminator according to the present invention;

FIG. 7 illustrates a pivoting operation of a portable illuminator according to the present invention; and

FIG. 8 illustrates a portable illuminator according to another embodiment of the preset invention;

### BEST MODE

Hereinafter, a portable illuminator according to the present invention will be described in detail with reference to the attached drawings. The purposes and features of the present invention will become more apparent upon review of the following detailed description of exemplary embodiments in conjunction with the drawings. Further, it should be noted that the same or similar reference numerals are applied to the same or similar parts and elements throughout the drawings.

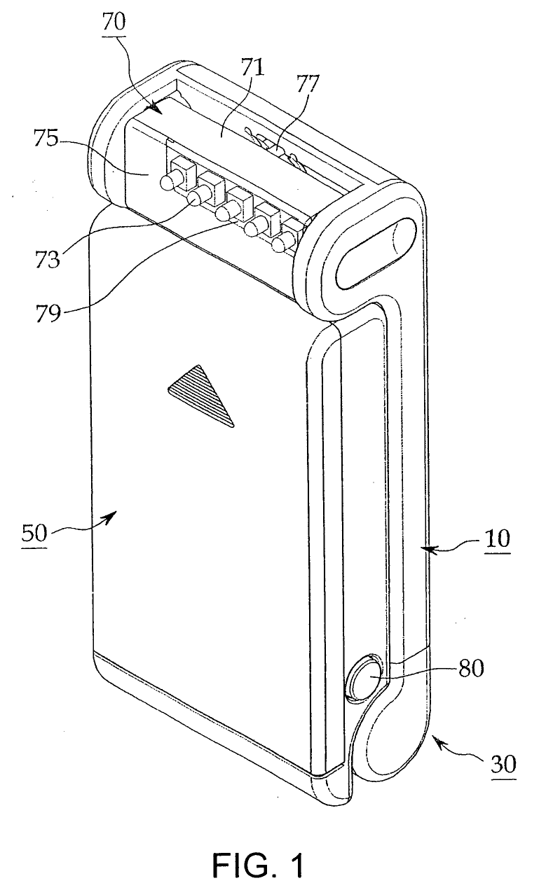

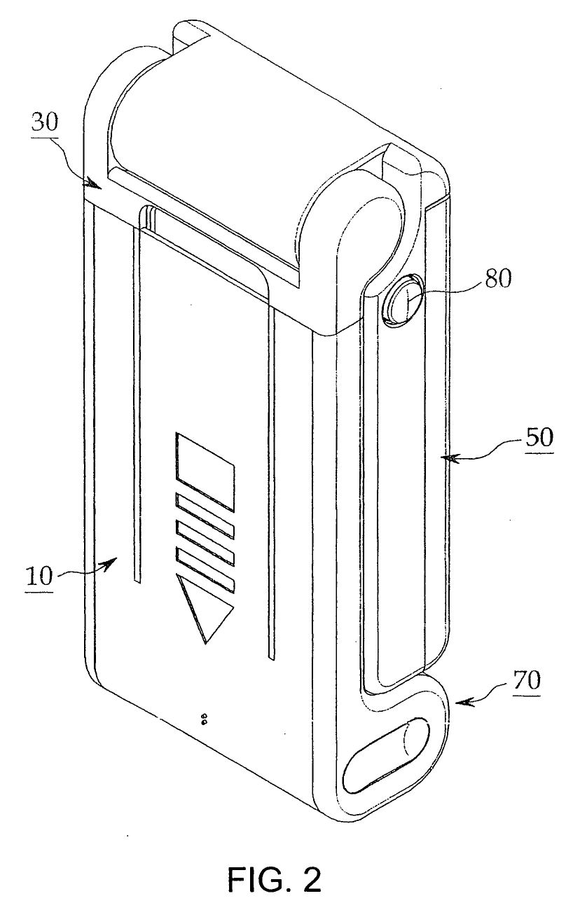

FIG. 1 is a front perspective view illustrating a portable illuminator according to the present invention, and FIG. 2 is a rear perspective view illustrating the portable illuminator of FIG. 1.

As illustrated in FIGS. 1 and 2, the portable illuminator according to the present invention is generally comprised of a power supply and control module 50, a guide and pivot main body 30 pivotably connected to the power supply and control module 50, a slide assembly 10 slidably guided on the guide and pivot main body 30, and a lamp module 70 mounted to an upper end of the slide assembly 10.

The lamp module 70 includes a lamp holder main body 71, on a rear surface of which a boss 77 is integrally formed, a circuit board 79 mounted in the lamp holder main body 71, a plurality of light emitting diodes (LEDs) 73 mounted on the circuit board 79, and a optical window 75 coupled to a front surface of the lamp holder main body 71.

At this time, the optical window 75 is formed of plastic, and is etched or polished to have a translucent surface, so that it can prevent refulgence.

Further, the lamp module 70 is constructed to adjust an angle to the slide assembly 10, which will be described in detail below.

The power supply and control module 50 is provided with a lamp switch 80 on one side thereof.

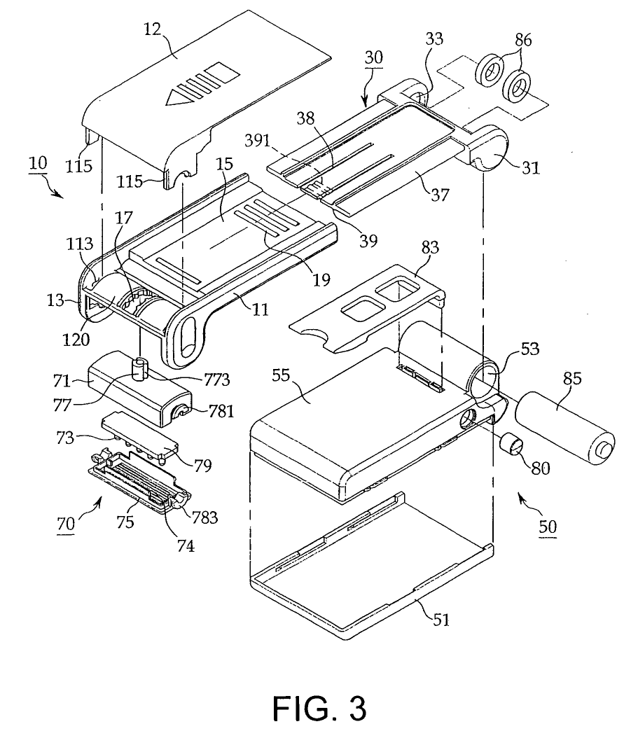

FIG. 3 is an exploded perspective view illustrating a portable illuminator according to the present invention.

A construction of the portable illuminator according to the present invention will be described in detail below with reference to FIG. 3.

The power supply and control module 50 includes a battery holder 55 holding a battery, and a cover 51 covering the battery holder 55. The cover 55 is seated on the battery holder 55, and then fastened or unfastened by sliding. The battery holder 55 is integrally formed with a shaft retainer 53 inserting a pivoting shaft 85 at one end thereof. The power supply and control module 50 is provided with a reading clip 83 on one side thereof.

The guide and pivot main body 30 is pivotably installed to the power supply and control module 50.

The guide and pivot main body 30 is generally composed of a flat guide plate 37, and a pair of pivot wings 31 integrally formed at one end of the guide plate 37.

The guide plate 37 has a guide ledge 39 protruding downwards for guiding, and a pair of slits 38 spaced apart from each other in parallel to longitudinal direction of the guide ledge 39. The guide ledge 39 between the pair of slits 38 is integrally formed with a stopper 391 on a bottom surface thereof. At this time, the pair of slits 38 serves to provide resilient force to the guide ledge 39 so as to allow the stopper 391 to smoothly slide.

The pair of pivot wings 31 are spaced apart from each other, each of which has a recess 33 formed on an inner wall thereof. The pivot wings 31 are pivotably coupled with the pivoting shaft 85 inserted into the shaft retainer 53 via annular rings 86.

In this manner, the guide and pivot main body 30 is to be pivotably mounted to the power supply and control module 50 by the pivot wings 31 and pivoting shaft 85.

The slide assembly 10 has a structure in which it is inserted into the guide and pivot main body 30. The slide assembly 10 includes a main body 11 and a cover 12 covering the main body 11. Between the main body 11 and the cover 12 is provided a space, into which the guide plate 37 of the guide and pivot main body 30 is inserted.

The main body 11 includes a flat guide recess 15 corresponding to the guide ledge 39 of the guide and pivot main body 30 on an inner side thereof, and a pair of ears 13 formed at one side of the guide recess 15. The pair of ears 13 are spaced apart from each other, between which a lamp seat 120 is integrally formed. Each coupling slit 113 is formed between each ear 13 and the lamp seat 120, and a pivoting slot 17 is formed in the middle of the lamp seat 120. Further, the flat guide recess 15 is formed with a plurality of semi-circular protrusions 19 on a top surface thereof, so as to allow the stopper 391 formed on the bottom surface of the guide ledge 39 to completely perform its own function.

The cover 12 has a corresponding structure so as to be coupled to the main body 11. Especially, coupled protrusions 115 are integrally formed at one side of the cover 12, so as to be inserted and coupled into the coupling slits 113 formed around the ears 13.

The lamp holder main body 71 of the lamp module 70 is provided with first pivot locking pieces 781 on opposite sides thereof, and the boss 77 is provided with grooves 773 on opposite sides thereof. The circuit board 79 having the plurality of LEDs 73 is mounted in the lamp holder main body 71, and the optical window 75 is mounted to the front surface of the lamp holder main body 71. The optical window 75 is provided with second pivot locking pieces 783 on opposite sides thereof, and a plurality of elongate channels 74 formed on an inner surface thereof. Each channel 74 may be implemented as a triangular or semi-circular channel, and if necessary, as any other shape of channel.

The first and second pivot locking pieces 781 and 783 are coupled to each other, and then inserted and seated into the ears 13. The boss 77 is pivotably inserted into the pivoting slot 17 of the lamp seat 120, which will be described in detail below. The plurality of channels 74 enlarge a specific surface area of the optical window 75, thereby serving to further diffuse light emitted by the LEDs 73.

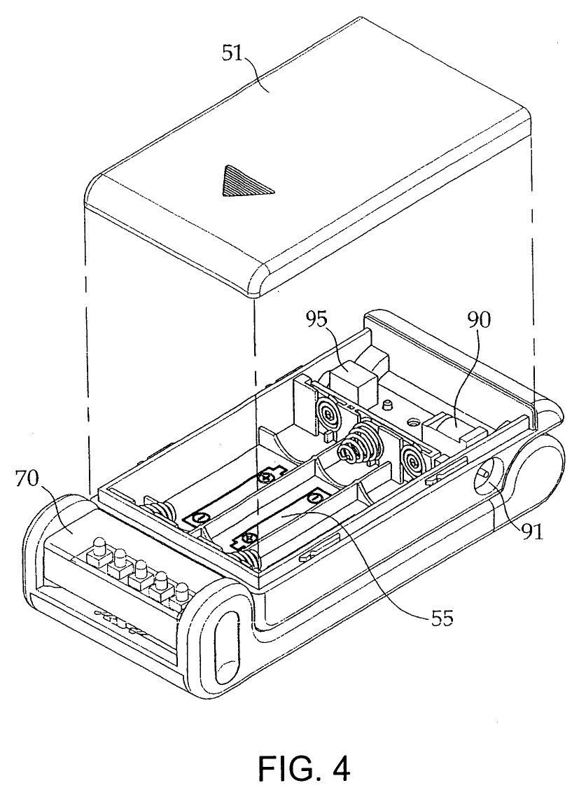

FIG. 4 is a detailed view illustrating a power supply and control module of a portable illuminator according to the present invention.

As illustrated in FIG. 4, the power supply and control module 50 includes the battery holder 55 in which a power supply used typically, such as a dry cell, is held, a charger 90 that charges the power supply, and a driver 95 that is supplied with power from the power supply in the battery holder 55 through the charger 90 and drives the lamp module 70.

The charger 90 is provided with a charging port 91, which is connected to an external charger. The driver 95 is connected with the lamp switch 80.

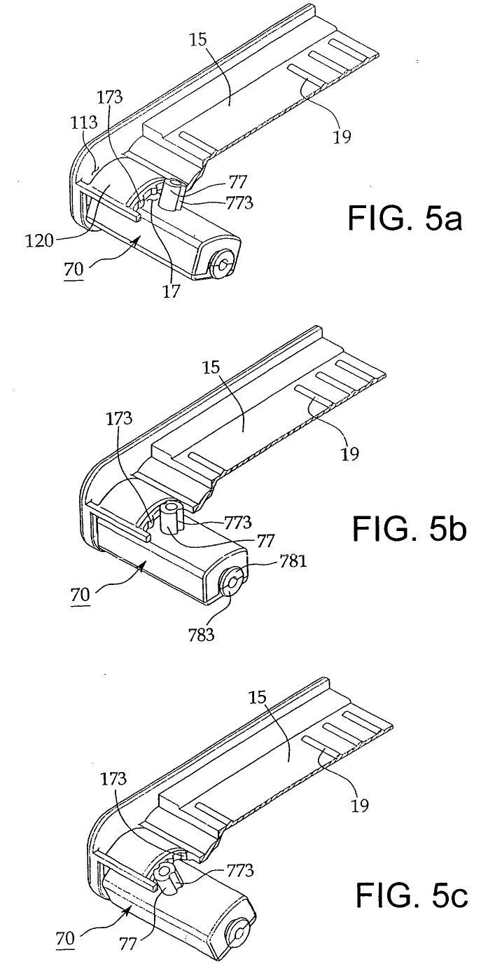

FIG. 5 is a detailed view illustrating operation of a lamp module in a portable illuminator according to the present invention.

As illustrated in FIG. 5, the boss 77 of the lamp module 70 is inserted into the pivoting slot 17 of the lamp seat 120. The pivoting slot 17 is provided with a plurality of semi-circular protrusions 173 on opposite inner walls thereof, and the semi-circular protrusions 173 are engaged to the grooves 773 of the boss 77.

Accordingly, as in FIG. 5(a), when the grooves 773 of the boss 77 are meshed with the semi-circular protrusions 173 located near the guide plate 37, the lamp module 70 is directed outward the illuminator, so that the light emitted from the lamp module 70 diverges outside.

Further, as in FIG. 5(b), when the lamp module 70 is rotated to a certain extent, and thus the grooves 773 of the boss 77 are meshed with the middle semi-circular protrusions 173, the lamp module 70 emits light toward the middle of the illuminator.

Finally, as in FIG. 5(c), when the lamp module 70 is further rotated, and thus the grooves 773 of the boss 77 are meshed with the semi-circular protrusions 173 located at a position farthest from the guide plate 37, the lamp module 70 is directed inward the illuminator, so that the light emitted from the lamp module 70 diverges inside.

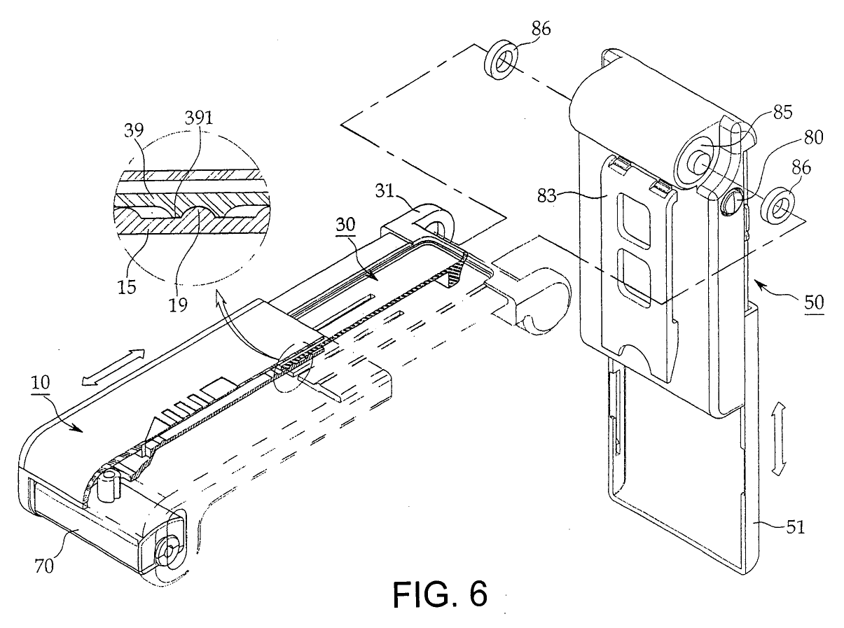

FIG. 6 illustrates a sliding operation of a portable illuminator according to the present invention.

Referring to FIG. 6, when pushing the slide assembly 10, to which the lamp module 70 is mounted, in an outward direction, the slide assembly 10 slides outside with respect to the guide and pivot main body 30. At this time, the stopper 391 formed on the bottom surface of the guide ledge 39 goes over the semi-circular protrusions 19 formed on the top surface of the guide recess 15, and in the mean time, when a user stops sliding the slide assembly 10, the stopper 391 is stopped by the semi-circular protrusions 19, so that the slide assembly 10 does no longer slide. Thus, the user adjusts the lamp module 70 up to a desired position, so that the light can be illuminated at a desired position.

In contrast, when the user pushes the slide assembly 10 in an inward direction, the slide assembly 10 slides inside with respect to the guide and pivot main body 30 by means of the same operation as described above.

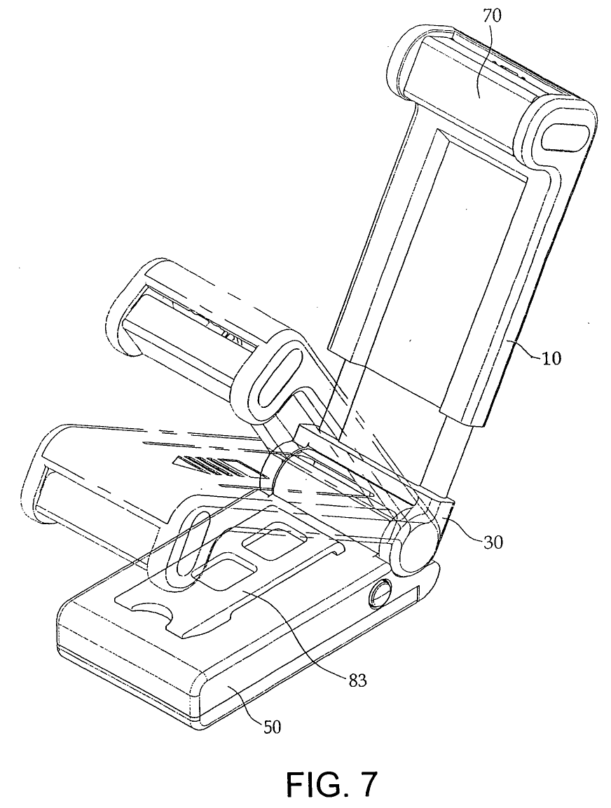

FIG. 7 illustrates a pivoting operation of a portable illuminator according to the present invention.

Referring to FIG. 7, when a user grasps and upwardly pivots the slide assembly 10 to which the lamp module 70 is mounted, the slide assembly 10 is pivoted about the pivoting shaft 85 with respect to the power supply and control module 50. Then, when the user sets the slide assembly 10 free at a desired angle, the slide assembly 10 is stopped at that angle by the annular rings 86 installed between the pivoting shaft 85 and the recesses 33 of the pivot wings 31. At this time, because the annular rings 86 are formed of a rubber or silicon material, the annular rings 86 give great frictional force, so that the slide assembly 10 can be stopped at a particular angle.

Further, when the user intends to read a book, he/she fits the reading clip 83 into an upper end of the book. In this case, the portable illuminator can be more conveniently used.

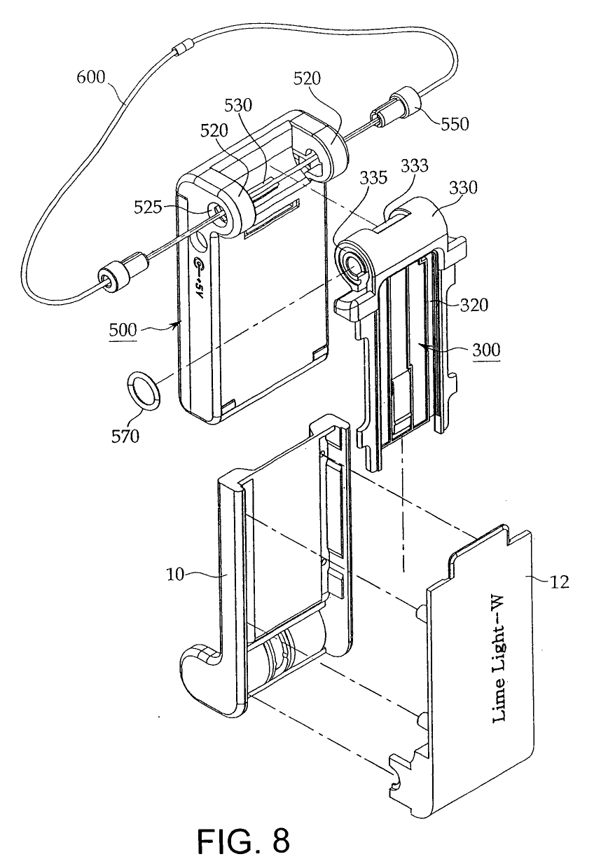

FIG. 8 illustrates a portable illuminator according to another embodiment of the preset invention. This portable illuminator according to another embodiment of the preset invention is equal to that according to an embodiment of the preset invention, excluding a coupling structure of the guide and pivot main body 30 and the power supply and control module 50. Hence, the detailed description of the same components between both embodiments will be omitted.

As illustrated in FIG. 8, the portable illuminator according to another embodiment of the preset invention includes a power supply and control module 500 and a guide and pivot main body 300.

The power supply and control module 500 is integrally formed with a pair of hinge wings 520 at opposite sides of one end thereof. Each hinge wing 520 is formed with a coupling hole 525. An auxiliary stopper 530, which is formed of a rubber or silicon material, is attached between the pair of hinge wings 520. The auxiliary stopper 530 gives frictional force to the guide and pivot main body 300 when the guide and pivot main body 300 is pivoted, thereby serving to stop the guide and pivot main body 300 at a predetermined angle.

The guide and pivot main body 300 is pivotably installed to the power supply and control module 500.

The guide and pivot main body 300 includes a guide plate 320, and a pivoting cylinder 330 mounted between the pair of hinge wings 520.

The pivoting cylinder 330 is provided with an annular channel 335 on one sidewall thereof, and a pivoting restriction recess 333 on an outer circumferential surface thereof. The pivoting cylinder 330 has a hollow shape. An annular ring 570 of a rubber material is inserted into the annular channel 335.

The pivoting restriction recess 333 allows the auxiliary stopper 530 to be received therein, thereby serving to prevent the pivoting cylinder 330 from pivoting beyond a predetermined angle by interaction with the auxiliary stopper 530.

Further, after the pivoting cylinder 330 of the guide and pivot main body 300 is seated on the pair of hinge wings 520 of the power supply and control module 500, coupling retainers 550 are inserted and coupled into the pivoting cylinder 330 through the coupling holes 525 of the hinge wings 520. Thereby, the guide and pivot main body 300 is pivotably coupled to the power supply and control module 500.

At this time, the annular ring 570 of a rubber material inserted into the annular channel 335 provides the frictional force, thereby acting as a stopper.

Further, each coupling retainer 550 has a hollow shape. A necklace 600 may be mounted and used in such a manner that it passes through the coupling retainers 550, the hinge wings 520, and the pivoting cylinder 330.

The portable illuminator according to various embodiments of the present invention can additionally have various functions by request of the user, as follows.

The portable illuminator according to the present invention may use a typical dry cell or a rechargeable battery. Further, it can urgently charge a power supply by connecting various mobile products (e.g. mobile phones, MPEG-1 Audio Layer 3 (MP3) players, Portable Media Players, digital cameras, digital videos, etc.), or charged by these products on the contrary.

Furthermore, the portable illuminator according to the present invention is provided with a wearing tool at a proper position, so that it can be used in a necklace type. The portable illuminator can be variously used, for instance, for camping, mountaineering, hiking, fishing, an auxiliary lamp of vehicle, a flashing light, a table lamp, an emergency lamp, and so on.

In addition, the portable illuminator can be used as a product for self-protection, which generates a warning sound to make an emergency aid request or is used during a night trip.

### INDUSTRIAL APPLICABILITY

As can be seen from the foregoing, the portable illuminator of the present invention has the following features.

First, the angle of the lamp module to which LEDs emitting light are mounted can be freely adjusted up and down upon the request of a user.

Second, the case having the LEDs can slide with respect to the main body, so that its length can be freely adjusted in multiple steps and the case can be easily accommodated.

Third, the main body and the lamp module are manufactured in a folder structure, so they can be folded and unfolded at various angles.

Fourth, the portable illuminator can maximize light emission from the lamp module to prevent refulgence, and can selectively use a primary battery, or rechargeable battery as power source.

Fifth, the portable illuminator can charge various mobile products, and vice versa.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A portable illuminator comprising:
a power supply and control module supplying power to control operation of a lamp;
a guide and pivot main body pivotably coupled to the power supply and control module;
a slide assembly slidably inserted into the guide and pivot main body; and
a lamp module mounted to one end of the slide assembly.

2. The portable illuminator as claimed in claim 1, wherein the power supply and control module includes:
a battery holder integrally formed with a shaft retainer at one end thereof, in order to insert a pivoting shaft;
a driver installed near the battery holder;
a lamp switch connected to the driver and turning on and off the lamp; and
a cover detachably coupled to the battery holder and the driver by means of sliding, in order to close battery holder and the driver.

3. The portable illuminator as claimed in claim 2, further comprising a charger adjacent to the battery holder, wherein the charger is connected with a charging port communicating with the outside.

4. The portable illuminator as claimed in claim 2, wherein the guide and pivot main body includes:
a guide plate having a guide ledge protruding downwards for guiding, a pair of slits spaced apart from each other in parallel to longitudinal direction of the guide ledge, and a stopper integrally formed on a bottom surface of the guide ledge between the pair of slits;
a pair of pivot wings integrally formed at one end of the guide plate with spaced apart from each other, and each having a recess formed on an inner wall thereof; and
the pivoting shaft inserted into the shaft retainer and pivotably coupled between the pivot wings via annular rings.

5. The portable illuminator as claimed in claim 4, wherein the slide assembly includes:
a main body having a flat guide recess corresponding to the guide ledge of the guide and pivot main body on an inner side thereof, a pair of ears formed apart from each other at one side of the guide recess, a lamp seat integrally formed between the pair of ears, coupling slits formed between each ear and the lamp seat, a pivoting slot formed in the middle of the lamp seat, and a plurality of semi-circular protrusions formed on a top surface of the guide recess; and
a cover having a corresponding structure so as to be coupled to the main body, and provided with coupled protrusions integrally formed at one side thereof so as to be inserted and coupled into the coupling slits formed around the ears.

6. The portable illuminator as claimed in claim 5, wherein the lamp module includes:
a lamp holder main body integrally formed with a boss on a rear surface thereof, and formed with first pivot locking pieces on opposite sides thereof;
a circuit board mounted in the lamp holder main body;
a plurality of light emitting diodes (LEDs) mounted on the circuit board; and
a optical window coupled to a front surface of the lamp holder main body, and formed with second pivot locking pieces on opposite sides thereof.

7. The portable illuminator as claimed in claim 6, wherein the boss is formed with grooves on opposite sides thereof, and the pivoting slot is provided with a plurality of semi-circular protrusions on opposite inner walls thereof, so as to allow the boss of the lamp module to be pivotably inserted into the pivoting slot of the lamp seat.

8. The portable illuminator as claimed in claim 6, wherein the optical window is additionally formed with a plurality of elongate channels formed on an inner surface thereof in order to further diffuse light emitted by the LEDs.

9. The portable illuminator as claimed in claim 6, wherein the optical window is subject to surface treatment by means of etching or polishing.

10. A portable illuminator comprising:
a power supply and control module having a pair of hinge wings which are integrally formed at opposite sides of one end thereof and each of which is formed with a coupling hole, an auxiliary stopper attached between the pair of hinge wings, a battery holder, a driver, a lamp switch, and a cover;
a guide and pivot main body pivotably coupled to the power supply and control module, and provided with a guide plate and a pivoting cylinder, the guide plate having a guide ledge protruding downwards for guiding, a pair of slits spaced apart from each other in parallel to longitudinal direction of the guide ledge, and a stopper integrally formed on a bottom surface of the guide ledge between the pair of slits, and the pivoting cylinder having an annular channel formed on one sidewall thereof, a pivoting restriction recess formed on an outer circumferential surface thereof, and an annular ring inserted into the annular channel;
coupling retainers inserted into the pivoting cylinder through the coupling holes of the hinge wings in order to pivotably couple the guide and pivot main body to the power supply and control module;
a slide assembly including: a main body having a flat guide recess corresponding to the guide ledge of the guide and pivot main body, a pair of ears formed apart from each other at one side of the guide recess, a lamp seat integrally formed between the pair of ears, coupling slits formed between each ear and the lamp seat, a pivoting slot formed in the middle of the lamp seat, and a plurality of semi-circular protrusions formed on a top surface of the guide recess; and a cover integrally formed with coupled protrusions at one side thereof so as to be inserted and coupled into the coupling slits formed around the ears; and
a lamp module mounted between the pair of ears of the slide assembly.

11. The portable illuminator as claimed in claim 10, wherein: the coupling retainers each have a hollow shape; and the coupling retainers, the hinge wings, and the pivoting cylinder have a necklace passing therethrough.

12. The portable illuminator as claimed in claim 3, wherein the guide and pivot main body includes:
a guide plate having a guide ledge protruding downwards for guiding, a pair of slits spaced apart from each other in parallel to longitudinal direction of the guide ledge, and a stopper integrally formed on a bottom surface of the guide ledge between the pair of slits;
a pair of pivot wings integrally formed at one end of the guide plate with spaced apart from each other, and each having a recess formed on an inner wall thereof, and
the pivoting shaft inserted into the shaft retainer and pivotably coupled between the pivot wings via annular rings.
